(19) United States
(12) Patent Application Publication
(10) Pub. No.: US 2009/0139120 A1
(43) Pub. Date: Jun. 4, 2009

(54) DISPLAY DEVICE AND GIFT HOLDER

(76) Inventor: Kelly Marie ALBERT, Brighton, MI (US)

Correspondence Address: HARNESS, DICKEY & PIERCE, P.L.C., P.O. BOX 828, BLOOMFIELD HILLS, MI, 48303, US

(21) Appl. No.: 12/276,469

(22) Filed: Nov. 24, 2008

Related U.S. Application Data
(60) Provisional application No. 61/004,727, filed on Nov. 29, 2007.

(51) Int. Cl. G09F 19/00

(52) U.S. Cl. 40/1

(57) ABSTRACT

The present invention relates to ornamental display devices for storing items such as keepsakes and gift cards.

### CROSS-REFERENCE TO RELATED APPLICATIONS

This application claims the benefit of U.S. Provisional Application No. 61/004,727, filed on Nov. 29, 2007; and 61/001,976, filed on Jan. 28, 2008. The entire disclosures of each of the above applications are incorporated herein by reference.

### FIELD

The present invention relates to ornamental display devices for storing items such as keepsakes and gift cards.

### BACKGROUND

Prior to the creation of the present invention, the only storage devices for special occasion events were items such as fabric covered boxes, painted boxes, bird cages and wishing wells, for example. These types of storage devices are generally only good for a single use or look tacky when utilized as a storage device for everyday use. These types of storage devices, if reusable, tend to offer little security when storing items of value, such as gift cards and keepsakes. Further, while these types of storage devices may be decorative per se, they do not offer any means for displaying personal items such as photographs and the like. Thus, there is a need in the art for multifunctional decorative display devices that can securely store items.

### SUMMARY

With the displaying of photos at wedding receptions, graduation parties, retirement parties, anniversary parties, and other types of celebrations, there has become an increasing need for a decorative display device which can not only be used to display photos and other items of interest, such as scrapbook pages, quotes, poems, scriptures and other mementos, but also a device that is functional to store cards typically containing currency and/or keepsakes to be displayed in the home or office. As will become clear upon review of the present invention, not only does the decorative display device serve as a gift card holder, for example, but alternative uses include use by businesses as a ballot-type box for inserting comments, business cards and questionnaires, while also allowing the business to take advantage of the display portion to share company photos and advertising, for example. Still other uses for the decorative display device include the opportunity to display keepsakes and mementoes obtained during special events, such as Champaign glasses, wedding favors, wedding invitations, programs, cake toppers, cake and knife servers, and other special wedding keepsake items. Further, items such as graduation caps and tassels, keepsakes from proms, homecoming, senior photos, award certificates, and other school keepsakes could be displayed.

Thus, it should be appreciated that virtually any memento or keepsake, sized to fit within the confines of the decorative device, can be displayed by the user as desired.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the combination decorative display device and container of the present invention;

FIG. 2 is a perspective view of the embodiment of FIG. 1 being utilized as a keepsake display device;

FIG. 3 is a disassembled exploded view of the display device in kit form;

FIG. 4 is a perspective view of the embodiment of FIG. 1 including a divider insert for segregating the device into various compartments;

FIG. 5 is a perspective view of a wall panel of the gift box with a slot for receiving a display item;

FIG. 6 is a perspective view of the base panel of the display device including a mounting member for securing a display item and a rotation mechanism shown in phantom;

FIG. 7 is a perspective view of a wall panel including a digital display mechanism; and

FIG. 8 is a perspective view of the base panel of FIG. 6 including automated rotation means.

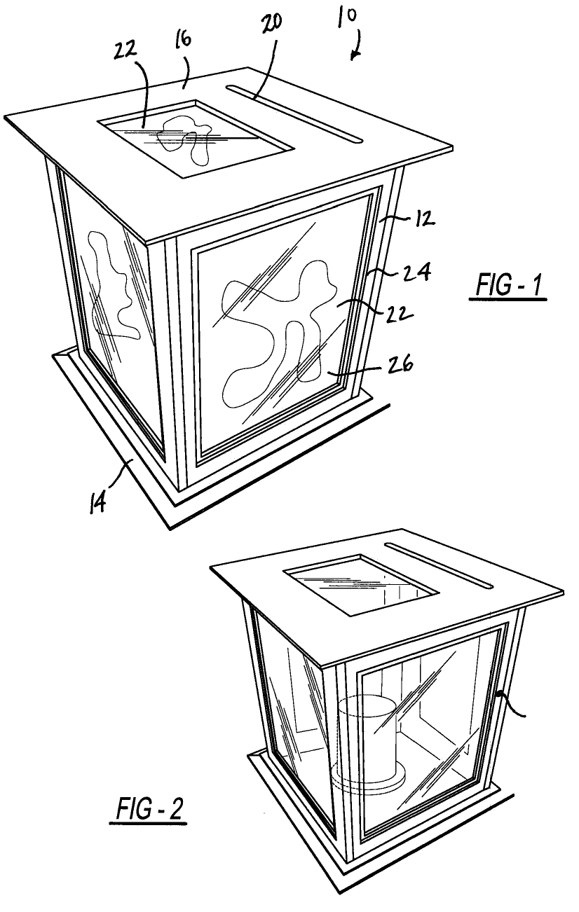

Corresponding reference numerals indicate corresponding parts throughout the several views of the drawings.

### DETAILED DESCRIPTION

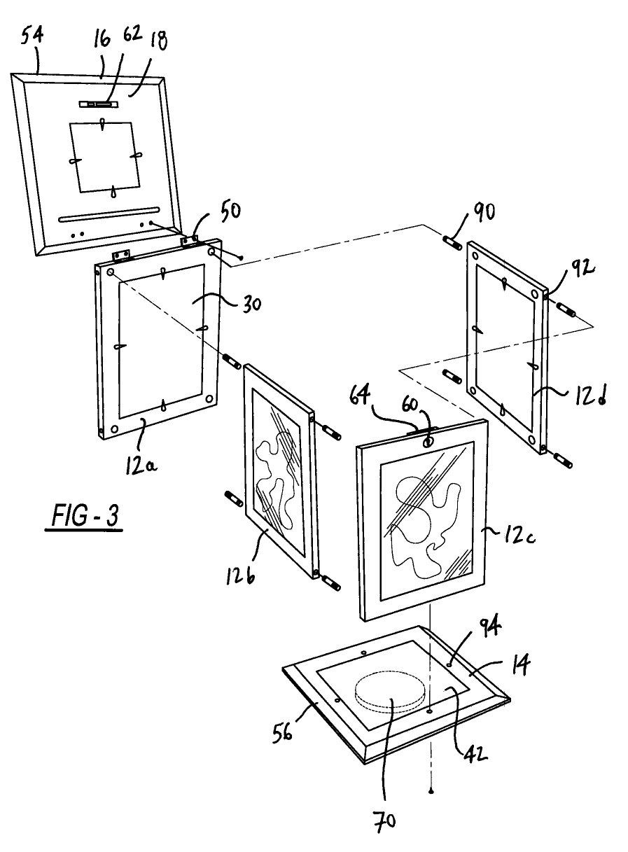

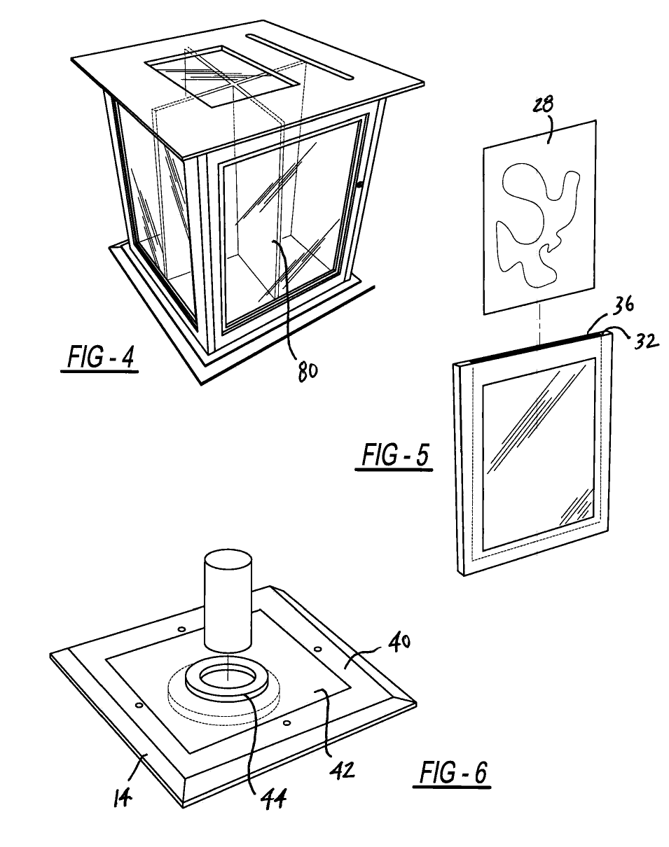

The decorative display device and gift keepsake holder 10 of the present invention generally includes a body defined by one or more sidewalls 12, a bottom panel 14 and a top panel 16 defining a self-contained open area. At least one of the sidewalls generally includes a display panel 22. The display panel 22 may include a frame portion 24 and a translucent portion 26 defined by the frame 24. Photographs or printable items 28 are installed by application to a backing element 30 with reclosable fasteners as shown in FIG. 3 or by insertion of an item 28 through a slot 36 provided along the top edge 32 of the frame as shown in FIG. 5.

The frame 24 may be constructed of wood, plastic, and/or wood or plastic composites, such as medium density fiberboard. The translucent portion is typically formed from glass or a thermoplastic material such as plexiglass.

While these are typically a plurality of sidewalls 12a-12d, which when attached to the top and bottom panels form an overall rectangular shaped box-like structure, it should be understood that a single sidewall could be employed such that the display device has an overall cylindrical shape. For convenience, the present invention will be described with regard to the box-like structure.

The bottom panel 14 is also typically formed from wood, plastic, metal, or wood/plastic composite materials and may include a peripheral portion 40 upon which the sidewalls 12 are assembled as will be described in greater detail below. The top surface 42 of the bottom panel 14 may include a mounting mechanism 44 as shown in FIG. 6 for securing a display item within the open area of the display device upon assembly.

The top panel 16 which is also made of material such as wood, plastic, metal or wood/plastic composite materials is affixed along the top edge 32 of one of the sidewalls 12. A hinge assembly 50 such as that shown in FIG. 3 may be employed to allow for unobstructed access to the containment area. Preferably, the hinge assembly is attached to the under surface 18 of the top panel such that it is concealed when the top panel is in a position to close off the top portion of the display device.

As demonstrated in numerous figures, the top and bottom panels may be sized such that they overhang the sidewalls enhancing the decorative appearance of the display device. Optionally, but preferably, the edges 54 and 56 of the top and bottom panels, respectively, may be beveled to still further enhance the aesthetic appearance of the display device. The top panel also generally includes a display panel 22 and an extended slot 20 through which gift cards can be inserted into the display device.

To secure the contents of the decorative display device, a locking mechanism 60 may be provided wherein a first portion 62 of the lock mechanism is disposed on the undersurface 18 of the top panel 16 and the mating portion 64 of the locking mechanism is disposed along the top edge of a sidewall generally opposite the hinge assembly.

In addition to the translucent portion 26, a matting material 30 may be used to enhance the decorative nature of the item being displayed along a given sidewall or the top panel, as such, a single photo or printed keepsake or a plurality of photos or printed keepsakes can be displayed in a sidewall or top panel location.

The undersurface of the bottom panel 14 may include a lazy susan-type mechanism 70 thereby allowing the display device to be rotated to maximize the display opportunities of any photos or keepsakes attached thereto as shown in FIG. 3. Optionally, a lazy susan-type mechanism including an automation device 72 may form the mounting mechanism 44 such that items displayed within the device may rotate in a carousel-like manner, as shown in FIG. 8.

Referring to FIG. 4, a divider mechanism 80 is shown in phantom which segregates the containment area into a plurality of sections. By providing a divided compartment, numerous keepsakes and/or display items can be housed and displayed at the same time by a single display device. The divider component as shown, has a substantial cross-shape and extends essentially from the base panel to the top panel when the top panel is in a closed position. Preferably, the divider mechanism has a soft fabric covering, such as velvet, velour, satin or fleece to provide padding and cushioning for the safe storage of breakable items being displayed. Obviously, any photographs or other items should be detached from the sidewall and matting, if employed, should be removed for ready visual access to the contents contained within the display device.

Referring to FIG. 6, the mounting mechanism 44 is shown can be utilized to facilitate display of an item such as a unity candle. However, the mounting mechanism is not limited to a shape which would host a candle but may be of a necessary geometry to host a floral bouquet or other items such as champagne glasses.

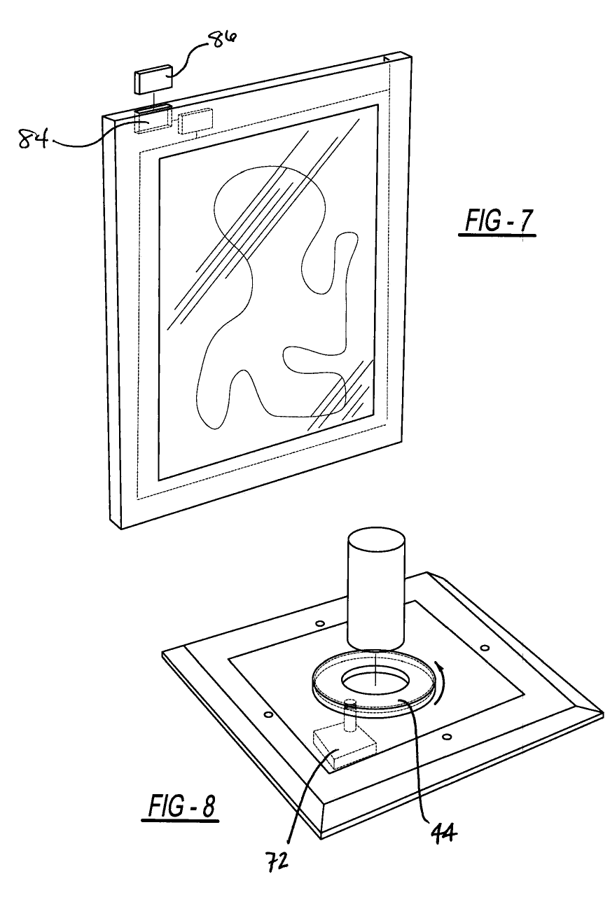

Referring to FIG. 7, there is shown an alternative embodiment wherein a sidewall 12 includes integrated electronics 84, perhaps with a replaceable display card 86, such that the translucent portion can display electronic or digital images as opposed to print media. Thus, using a digital computer photo option, images can be displayed digitally on either a single sidewall or multiple sidewalls. If desired, the photos rotate to each sidewall display area after a designated time thereby affording maximum opportunities to view items to be displayed along the sidewalls. While not shown, the display device may be linked to a remote computer which feeds digital information to the display device to provide an endless number of display items.

As demonstrated most clearly in FIG. 3, the display device of the present invention typically comes in kit form which can be easily assembled as summarized below. Typically, each of the sidewalls 12a-12d are adjoined utilizing the locking pins 90 which are inserted in to the preformed holes 94 positioned along the edges of the sidewalls and/or the inner wall of the sidewall. Importantly, there are predrilled holes in the bottom edge (not shown) which are intended to align with the predrilled holes 94 occurring along the perimeter of the base panel. Once the sidewalls 12a-12d are assembled, the sidewalls can be tipped along one side and the bottom panel 14 attached utilizing fasteners 90 through the preformed holes. Thereafter, the partially assembled device can be positioned upright, such that the top panel 16 can be attached via the preinstalled hinges 50. Again, fasteners such as screws or pins are utilized to fasten the top panel along the top edge of the appropriate sidewall.

Once the top panel is attached to the hinge assembly, the top panel should be rotated downwardly to cover the containment area of the display device to ensure that the locking mechanism is fully functional. Alternatively, the top panel can first be secured to the sidewalls and thereafter the bottom panel attached via the predrilled holes.

To the extent that photographs and/or printed items are to be utilized with the display device, it is recommended that the items are first inserted or attached to the sidewalls or top panel prior to assembling the device. It should be understood that such items could also be inserted after assembly; but it is believed to be more convenient to attach or insert them first.

Upon review of the forgoing, it should be clear that the device of the present invention is multi-functional in that it can be used for various occasions and is intended for long-term use. Unlike other known display boxes per se, the present invention gives the use the option of storing items disposed in the containment area in a concealed manner such as when gift cards including money are stored therein during a wedding reception or other festive occasions, for example. Alternately, the display device can be easily modified at the user's discretion when it is desirable to display items contained therein.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A decorative display device comprising:
a body including a top panel, a bottom panel and at least one sidewall defining a containment area, said top panel being pivotally attached to said at least one sidewall to allow for unobstructed access to said open area when said top panel is in an open position and said top panel including an elongated slot extending therethrough whereby items can be deposited into the containment area when said top panel is in a close position, said at least one of said sidewalls or said top panel including one or more display panels.

2. The decorative display device of claim 1 wherein said at least one display panel includes a frame, an inner backing against which an item can be positioned for display and an outward translucent portion through which an item can be viewed.

3. The decorative display device of claim 1 wherein at least one sidewall includes a translucent portion allowing for visual access to items disposed within the containment area.

4. The decorative display device of claim 3 further comprising a divider mechanism disposed therein for segmenting the containment area into distinct sections.

5. The decorative display device of claim 4 further comprising a mounting mechanism for securing items within the containment area.

6. The decorative display device of claim 1 wherein a plurality of the sidewalls include display panels.

7. The decorative display device of claim 1 wherein at least one display panel is a digital display.

8. The decorative display device of claim 1 wherein said device includes a rotatable base.

9. The decorative display device of claim 1 wherein said top panel is hingedly connected to a sidewall.

10. The decorative display device comprising:
a body including a top panel, a bottom panel and a plurality of sidewalls arranged and connected to give the device a box-like structure having an open containment area therein, said top panel including an elongated slot for inserting items into the containment area when said top panel is in a closed position and a hinge assembly connected to both said top panel and a sidewall to allow for pivoting of the top panel to an open position thereby allowing access to the containment area, and at least one of said top panel or said sidewalls including a display panel for selectively displaying items on said device.

11. The decorative display device of claim 11 wherein said at least one display panel includes a frame, an inner backing against which an item can be positioned for display and an outward translucent portion through which an item can be viewed.

12. The decorative display device of claim 11 wherein at least one sidewall includes a translucent portion allowing for visual access to items disposed within the containment area.

13. The decorative display device of claim 12 further comprising a divider mechanism disposed therein for segmenting the containment area into distinct sections.

14. The decorative display device of claim 13 further comprising a mounting mechanism for securing items within the containment area.

15. The decorative display device of claim 11 wherein a plurality of the sidewalls include display panels.

16. The decorative display device of claim 11 wherein at least one display panel is a digital display.

17. The decorative display device of claim 11 wherein said device includes a rotatable base.

18. A kit for making a decorative display device for storing items therein in either a concealed or a visible manner depending on the user's needs, said kit comprising:
a top panel, a bottom panel and a plurality of sidewalls;
a plurality of fasteners to secure the top and bottom panels to the sidewall to form a structure having a containment area;
a hinge assembly to allow for manipulation of one of at least one of the top panel, the bottom panel or a sidewall between open and closed positions to allow for access to the containment area; and
one or more display panels formed as part of either the top panel or a sidewall allowing items to be selectively displayed by the device.
